(19) United States
(12) Patent Application Publication
(10) Pub. No.: US 2008/0241520 A1
(43) Pub. Date: Oct. 2, 2008

(54) HYDROPHILIC ELEMENTS

(75) Inventors: Toshiya Takahashi, Kanagawa (JP); Daisuke Onodera, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/058,742

(22) Filed: Mar. 30, 2008

(30) Foreign Application Priority Data
Mar. 30, 2007 (JP) 2007-094086

(51) Int. Cl. B32B 7/02; B32B 9/00

(52) U.S. Cl. 428/332; 428/688

(57) ABSTRACT

The hydrophilic element comprising a base and a hydrophilic layer formed of an inorganic oxide on a surface of the base, the hydrophilic layer having a columnar structure composed of columns that form angles of 10 to 70 degrees with respect to a line normal to the base, exhibits not only excellent hydrophilicity and water retention but also high strength and stability over time and which yet is easy to produce and best suited for use as humidity modifiers and anti-fogging elements, in particular, anti-fogging films.

The entire contents of documents cited in this specification are incorporated herein by reference.

### BACKGROUND OF THE INVENTION

The present invention relates to hydrophilic elements comprising a hydrophilic layer formed on surfaces of bases such as polymeric films; the invention particularly relates to hydrophilic films that are best suited for use as anti-fogging or fog-resistant films.

It has been known that a variety of lenses, mirrors and even glass plates and the like can be rendered “fog-resistant,” namely, can be prevented from fogging by forming a hydrophilic film on surfaces of bases such as lenses.

The hydrophilic film can be formed on a base's surface by forming (depositing) an inorganic oxide film such as a silicon dioxide (SiO₂) film through a vapor-phase deposition technique such as ion plating, sputtering or vacuum evaporation so that the base's surface is rendered porous.

If the base's surface is thusly rendered porous, it gets more wettable by capillarity and is enhanced in hydrophilicity such that water drops adhering to the base's surface are absorbed in asperities to provide fog resistance.

For example, JP 2901550 B discloses an anti-fog element comprising a base, a transparent film of a photocatalytically reactive substance that is formed on a surface of the base and which is capable of photocatalytic reaction, and a transparent inorganic oxide film such as a silicon dioxide film that is formed in a porous state on top of the transparent film of a photocatalytically reactive substance.

This anti-fog element has such an advantage that even if organic matter such as wax, nitrogen oxide or the like gets into the openings in the porous inorganic oxide film and sticks there, the film of photocatalytically reactive substance initiates a photocatalytic reaction that decomposes away the wax or the like; as the result, a possible drop in hydrophilicity can be prevented to ensure that the element maintains fog resistance over an extended period of time.

JP 3694881 B discloses an anti-fogging article that is produced by a process comprising forming the topmost layer of a single- or multi-layered anti-reflective film from an inorganic substance by vacuum evaporation with a gas being introduced, and thereafter treating the topmost layer with a hydrophilic substance such that it is fixed in the fine pores or fine asperities in the topmost layer.

This anti-fogging article has the hydrophilic substance fixed in the film of low filling factor, whereby its density is sufficiently enhanced to maintain adequate anti-fogging performance and wear resistance.

JP 2003-116689 A discloses an anti-fogging mirror that comprises a base with a reflective film and a coating of crystalline tin oxide that is formed on the base's surface and which comprises a plurality of columns that are erected normal to the base and convex at the tip and which have fine asperities formed in the convex surface.

Since the tin oxide coating of this anti-fogging mirror has a columnar structure that exhibits fog resistance, water drops that have entirely or partly reached the small gaps between columns will be absorbed into the coating by capillarity; what is more, each column has fine asperities in its surface, so the coating has such a large surface area that the water drops will sufficiently wet its surface to easily spread over it, whereupon fog is advantageously prevented to ensure that the mirror will display superior anti-fogging performance.

### SUMMARY OF THE INVENTION

The anti-fogging performance of these films having porous surfaces or columnar crystal structures basically depend on the surface area of the hydrophilic film and is determined by the amount of water drops that it can absorb.

Each of the anti-fogging elements described above has satisfactory fog resistance. However, the requirements that should be met by anti-fogging elements tend to become increasingly rigorous these days and the advent of an anti-fogging element is desired that displays more superior fog resistance even in a more hostile environment and which also possesses superior stability over time.

The present invention has been accomplished with a view to solving the above-mentioned problem of the prior art and has as its object providing a hydrophilic element that exhibits not only excellent hydrophilicity and water retention but also high strength and stability over time and which yet is easy to produce and best suited for use as humidity modifiers and anti-fogging elements, in particular, anti-fogging films.

In order to achieve the above-mentioned objects, the present invention provides a hydrophilic element comprising:

a base; and

a hydrophilic layer formed of an inorganic oxide on a surface of the base, the hydrophilic layer having a columnar structure composed of columns that form angles of 10 to 70 degrees with respect to a line normal to the base.

In the hydrophilic element of the present invention, the hydrophilic layer preferably has a thickness of from 100 to 3,000 nm.

The hydrophilic element is preferably an anti-fogging film having the base in film form.

The hydrophilic element of the present invention which has the above-described construction is characterized in that it has a hydrophilic layer made of an inorganic oxide layer and that the hydrophilic layer has a columnar structure comprising columns that form angles of 10 to 70 degrees with the line normal to the base, namely, columns that are inclined at specified angles with the line normal to the base.

As the result, compared to a columnar structure comprising columns formed perpendicular to the base, the hydrophilic layer in the hydrophilic element of the present invention has such a large surface area that it can absorb a sufficiently large amount of water to display a markedly outstanding hydrophilicity so that when it is utilized as an anti-fogging film, it displays a markedly outstanding fog resistance. Furthermore, because of the columnar structure comprising columns that are formed at an angle, the gaps between columns can be sufficiently widened to secure a large enough space to allow for the release of a stress, whereby the hydrophilic element of the present invention has a markedly satisfactory strength in the face of an environmental change or an externally applied force, with the additional advantage of satisfactory stability over time.

And yet, the hydrophilic element of the present invention which has such superior characteristics is easy to manufacture since it can be produced by simply utilizing a vapor-phase deposition technique such as vacuum evaporation and setting up the substrate at an angle.

### BRIEF DESCRIPTION OF THE DRAWINGS

FIG. 1 is a schematic diagram showing an exemplary case where the hydrophilic element of the present invention is utilized as an anti-fogging film;

FIG. 2 is a microphotograph of an example of the hydrophilic element of the present invention as it is utilized as an anti-fogging film;

FIG. 3 is a schematic diagram for illustrating the hydrophilic element of the present invention; and

FIG. 4 is a schematic diagram for illustrating an example of the process for producing the hydrophilic element of the present invention.

### DETAILED DESCRIPTION OF THE INVENTION

On the following pages, the hydrophilic element of the present invention is described in detail on the basis of the preferred embodiment depicted in the accompanying drawings.

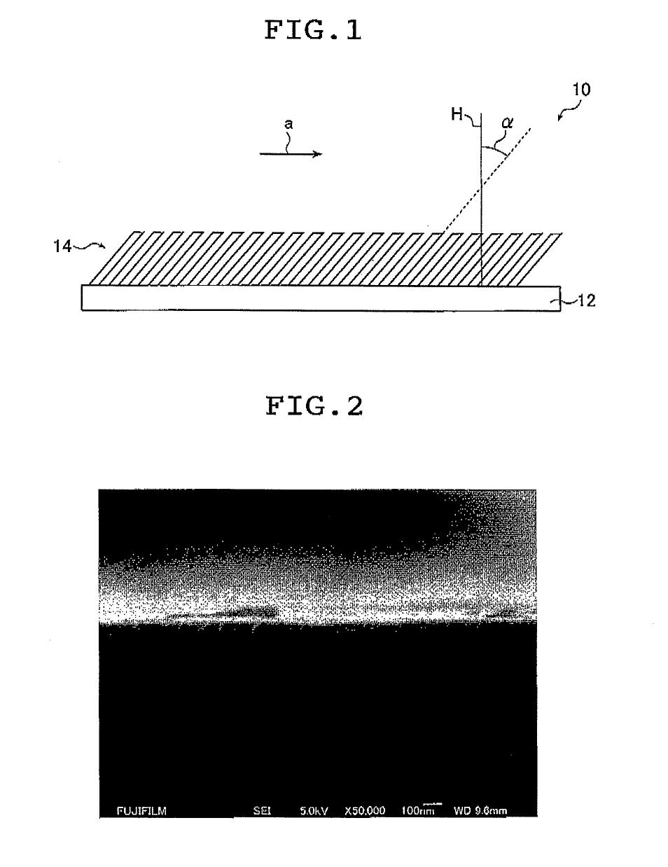

FIG. 1 is a schematic diagram showing an exemplary case where the hydrophilic element of the present invention is utilized as an anti-fogging film. FIG. 2 shows a microphotograph of an anti-fogging film that utilizes the hydrophilic element of the present invention.

The anti-fogging film generally indicated by 10 in FIG. 1 comprises a substrate 12 and an anti-fogging layer (hydrophilic layer) 14 formed on a surface of the substrate 12. As shown in FIG. 1, the anti-fogging layer 14 has a columnar structure that is composed of columnar shapes (columns) of an inorganic oxide that have grown independently of one another; the anti-fogging layer 14 is such that the angle α the individual columns form with the line H normal to the substrate 12 (its surface) (H being the normal to the surface of the substrate 12) is in the range of from 10 to 70 degrees.

In the present invention, the substrate 12 is not limited in any particular way and a variety of flexible or non-flexible sheets may be employed, as exemplified by polymeric films and glass sheets.

In addition, the present invention is not limited to the anti-fogging films that have the anti-fogging layer 14 formed on top of the substrate 12. Other possible applications of the present invention may have the anti-fogging layer 14 formed on top of such bases (substrates) as exemplified by various articles including: a variety of mirrors such as rear-view mirrors on vehicles, mirrors in bathrooms, mirrors in toilets, dental mirrors, and traffic mirrors; a variety of lenses such as spectacles lenses, optical lenses, camera lenses, endoscopic lenses, lighting lenses, semiconductor lenses, and copier lenses; prisms; window glass on buildings and lookout towers, and other glasses for use as building materials; window glass on automobiles, railroad vehicles, aircrafts, ships, submarines, snow vehicles, ropeway gondolas, gondolas in amusement parks, and on various other vehicles; windshield glass on automobiles, railroad vehicles, aircrafts, ships, submarines, snow vehicles, snowmobiles, motorcycles, ropeway gondolas, gondolas in amusement parks, and on various other vehicles; glass on frozen food display cases; cover glass on measuring instruments; shields to be provided on protective goggles, sporting goggles, protective masks, sporting masks, and helmets; as well as films to be attached to surfaces of these articles.

In the present invention, the anti-fogging layer (hydrophilic layer) 14 is formed of an inorganic oxide. Every type of inorganic oxide can be used as long as it is hydrophilic. For various reasons such as the ability to provide superior anti-fogging performance, ease in manufacture, safety on use, and inertness to the base and members peripheral to the anti-fogging layer, preferred examples include silicon (Si) oxides, aluminum (Al) oxides, yttrium (Y) oxides, zirconium (Zr) oxides, tin (Sn) oxides, titanium (Ti) oxides, tantalum (Ta) oxides, and hafnium (Hf) oxides. Among these, silicon oxides and aluminum oxides are particularly preferred. The inorganic oxides may be amorphous.

The anti-fogging layer 14 may be formed (deposited) by a vapor-phase deposition technique such as vacuum evaporation using the same film-depositing material as is employed in ordinary vacuum evaporation in accordance with the film to be deposited (formed). An advantageous method for producing the anti-fogging layer will be described later in detail.

If necessary, the anti-fogging layer 14 may contain a material that has an antibacterial function. The antibacterial material may be exemplified by mercury, silver, copper, zinc, iron, lead, bismuth, etc. Specific examples include metals such as silver, copper, zinc and nickel or their ions that are supported on silicate based carriers, phosphate based carriers, oxides, glass, potassium titanate, amino acids, etc.

More specific examples include, but are not limited to, zeolite based antibacterial agents, calcium silicate based antibacterial agents, zirconium phosphate based antibacterial agents, calcium phosphate based antibacterial agents, zinc oxide based antibacterial agents, soluble glass based antibacterial agents, silica gel based antibacterial agents, activated charcoal based antibacterial agents, titanium oxide based antibacterial agents, titania based antibacterial agents, organometallic antibacterial agents, ion exchanger ceramics based antibacterial agents, layered phosphate/quaternary ammonium salt based antibacterial agents, and antibacterial stainless steel.

If the antibacterial material is contained at all, its amount is preferably adjusted to be within the range of from about 0.001 to about 20 wt %.

If a film of inorganic oxide is formed by a vapor-phase deposition technique, there sometimes occurs the case where no film having the same composition as the theoretical ratio can be formed, but according to the study conducted by the present inventors, a more advantageous anti-fogging property (hydrophilicity) is developed as the inorganic oxide that forms the anti-fogging layer (hydrophilic layer) 14 has a composition closer to the theoretical ratio.

Therefore, in the case of forming the anti-fogging layer 14 from a silicon oxide (silicon dioxide film (SiO₂)), the silicon dioxide film preferably has an O/Si ratio of at least 1.8. Such an inorganic oxide film may be prepared by, for example, depositing an inorganic oxide with oxygen gas being introduced at a pressure within a specified range.

As already mentioned, the anti-fogging layer (hydrophilic layer) 14 is made of an inorganic oxide and has a columnar structure comprising individually independent columns (columnar shapes of the inorganic oxide) that form an angle α of 10 to 70 degrees with the line H normal to the substrate 12.

The advantage of providing this columnar structure which comprises columns that form an angle α of 10 to 70 degrees with the line H normal to the substrate 12 (which are hereinafter referred to as “inclined columns”) is that given the same film thickness, the surface area can be markedly increased over the anti-fogging layer disclosed in JP 2003-116689 A which has a columnar structure comprising columns that are perpendicular to the substrate (i.e., the above-defined angle α is zero degrees); in other words, the ability of the anti-fogging layer 14 to absorb water by capillarity is significantly improved to achieve markedly outstanding fog resistance.

The anti-fogging film 10 of the present invention is preferably formed by a vapor-phase deposition technique such as vacuum evaporation (vacuum deposition technique). It should be noted here that according to the study by the present inventors, those inclined columns which are grown by a vapor-phase deposition technique are not as close to each other or are not as crowded together as the columns that are grown perpendicular to the substrate but are more spaced apart and become more independent of each other. As a result, the volume of water that can be absorbed is improved and so is the anti-fogging property; at the same time, contact or compression between adjacent columns can be reduced and there are provided spaces that allow a stress to be effectively released so that even if the anti-fogging layer 14, once formed, is subjected to a temperature variation, a change in the use environment, an external force or other stresses, it will not be damaged (certainly will not break by itself due to mutual interference by adjacent columns), whereby the anti-fogging layer 14, namely, the anti-fogging film 10 that excels in strength is afforded. In addition, the anti-fogging layer 14 in the process of deposition can be advantageously prevented from being damaged.

As a further advantage, the anti-fogging layer 14 which comprises the above-characterized inclined columns excels in stability over time, in particular, the stability of fog resistance over time.

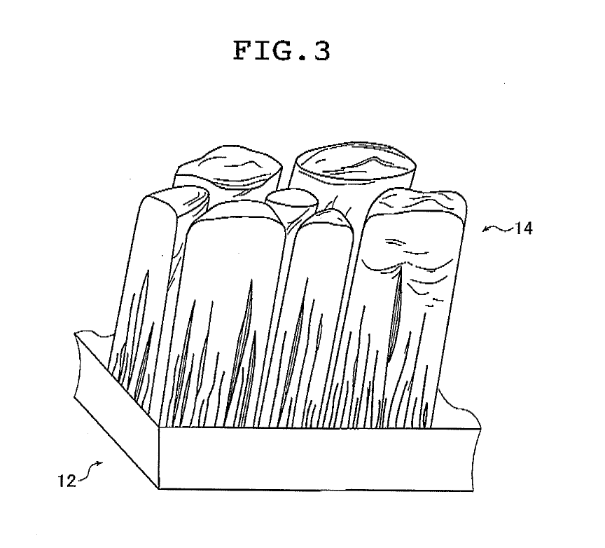

In FIG. 1, each of the columns that compose the anti-fogging layer 14 is depicted simply as a single entity in order to visualize the constitution of the present invention; in fact, however, when an inorganic oxide layer of a columnar structure comprising inclined columns is formed by a vapor-phase deposition technique, column growth occurs as shown schematically in FIG. 3, where independent columns first grow and as the crystals continue to grow, they gradually integrate into a single columnar shape. In addition, each column is formed of fine grains, which increase in size from bottom (closer to the substrate) to top (toward the surface of the anti-fogging layer). In other words, the anti-fogging layer 14 which is coarse in the lower part gradually becomes denser in the upper part.

As a result, not only the above-described effect of increasing the surface area but also the effect of increasing the gap between adjacent columns will develop to a greater extent and, what is more, the moisture on the surface can be advantageously directed downward, thereby affording the anti-fogging film 10 that has superior fog resistance and strength.

Furthermore, as will be described later in detail, the anti-fogging film 10 (anti-fogging layer 14) is very simple to manufacture since it can be produced by merely forming the anti-fogging layer 14 through a vapor-phase deposition technique such as vacuum evaporation, with the substrate being positioned at an angle.

To be more specific, the anti-fogging film (hydrophilic film) 10 of the present invention is composed of an inorganic oxide and has a columnar structure comprising inclined columns; these features contribute to increasing the surface area of the anti-fogging layer 14 and adjusting the filling ratio of the inorganic oxide in the anti-fogging layer 14 to lie within an optimum range, thereby enabling the production of an anti-fogging film that excels in fog resistance (hydrophilicity) and has high strength.

The anti-fogging layer 14 which is formed of an inorganic oxide has additional advantages of excelling in heat resistance, transmittance of visible light (transparency), chemical resistance, weatherability, and friction resistance.

As set forth above, the angle α formed by columns that compose the anti-fogging layer 14 having a columnar structure ranges from 10 to 70 degrees with respect to the line normal to the substrate 12.

If the angle α is less than 10 degrees, there often occurs the case where the effect of inclining the columns is not fully realized, namely, one cannot obtain an anti-fogging film that is satisfactorily superior to the conventional anti-fogging film having a vertical columnar structure. On the other hand, if the angle α exceeds 70 degrees, so-called haze (irreversible fog) will easily occur.

For various reasons such as the ability to produce the anti-fogging layer 14 having even higher fog resistance and strength, the angle α is preferably in the range of from 25 to 45 degrees.

The above-defined angle α that is formed by columns that compose the anti-fogging layer 14 (hydrophilic layer) may be obtained by the following procedure: a cross section of the anti-fogging layer 14 as seen in a direction that crosses at right angles the direction in which the film (columns) is inclined (parallel to the surface of the substrate 12, as indicated by the arrow “a” in FIG. 1) is observed with a scanning electron microscope (SEM) or a transmission electron microscope (TEM) and the angle α each column forms with the line H normal to the substrate 12 is measured.

More specifically, a cross section which is parallel to the direction in which the most inclining column is oriented in the columnar structure of the anti-fogging layer 14 and is orthogonal to the substrate 12 is formed, then observed with a microscope such as SEM in a direction orthogonal to the cross section so that the angle α each column forms with the line H normal to the substrate 12 may be measured.

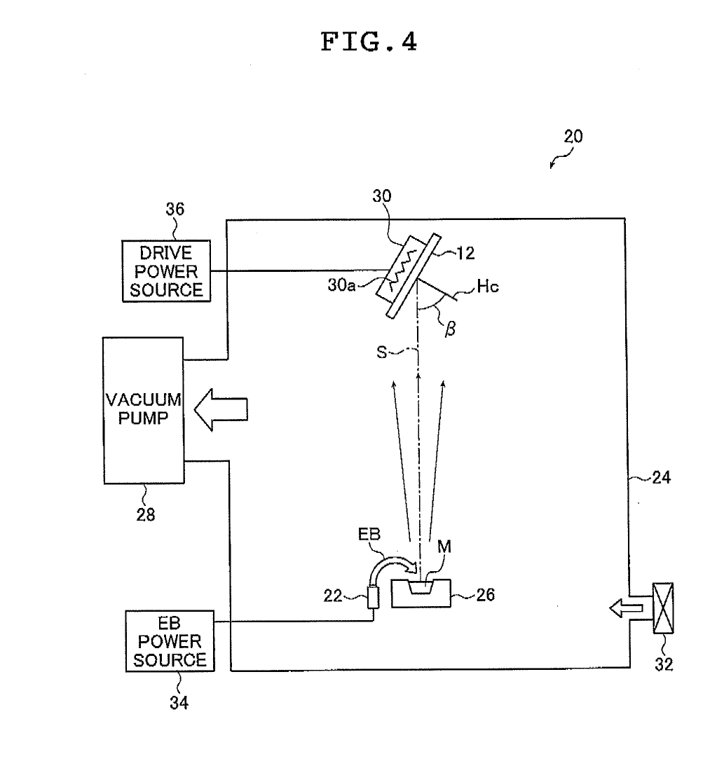

For example, in the case of the anti-fogging film 10 having the anti-fogging layer 14 formed by the production process to be described later with reference to FIG. 4, the direction from the line Hc normal to the substrate 12 toward the line S connecting the center of the evaporation source 26 to the center of the substrate 12 is generally regarded as the direction in which the most inclining column is oriented. Therefore, the cross section parallel to the direction in which the most inclining columnar crystal is oriented is parallel to the plane the line Hc forms with the line S.

The columns that compose the anti-fogging layer 14 are not necessarily linear but may often have portions different in angle. In such cases, it is preferable to measure the angle α in accordance of the thickness of the anti-fogging layer 14.

In the case where the anti-fogging layer 14 has a thickness of less than 300 nm, a preferable method involves excluding the 10% regions of the anti-fogging layer 14 in its thickness direction on the sides of the surfaces of the substrate 12 (or the layer underlying the anti-fogging layer 14) and the anti-fogging layer 14, respectively, from the anti-fogging layer 14 to set its central 80% region in the thickness direction; measuring the maximum angle and minimum angle of the column in the central 80% region; and determining the average of the measurements as the column angle α.

In the case where the anti-fogging layer 14 has a thickness of at least 300 nm, a preferable method involves excluding the 30 nm regions in the thickness direction on the sides of the surfaces of the substrate 12 (or the layer underlying the anti-togging layer 14) and the anti-fogging layer 14, respectively, from the anti-fogging layer 14 to set its central region in the thickness direction; measuring the maximum angle and minimum angle of the column in the central region; and determining the average of the measurements as the column angle α.

In implementing the method of measuring the column angle α, if the column is curved or has a curved portion, the maximum angle and minimum angle of the column may be measured by setting a tangent on the curved portion of the column and measuring the angle at the tangent.

In the present invention, the column angle in the anti-fogging layer 14 may also be determined by forming as above a cross section which is parallel to the direction in which the most inclining column is oriented in the anti-fogging layer 14 and is orthogonal to the substrate 12, observing the formed cross section with a microscope such as SEM in a direction orthogonal to the cross section, measuring any different 10 columns for their angle α with respect to the line H normal to the substrate 12, and calculating the average of the measurements.

If a column has a region different in angle α in the above case, its central region may be set as above before 10 columns are measured for their angle α.

More specifically, depending on the thickness of the anti-fogging layer 14, the central 80% region in the thickness direction is set at an anti-fogging layer thickness of less than 300 nm, whereas the central region obtained by excluding the 30 nm regions on the sides of the surfaces of the substrate 12 and the anti-fogging layer 14, respectively, from the anti-fogging layer 14 is set at an anti-fogging layer thickness of at least 300 nm. Then, the angle α is measured at the central regions of any different 10 columns and the average of the measurements is calculated for the column angle in the anti-fogging layer 14.

In the measurement of the column angle α, a portion where abnormal growth occurred due to cracks or other defects and a portion having been broken during the formation of the cross section are not adopted as the position where the angles (maximum angle and minimum angle) of the column are to be measured.

In the present invention, it is of course preferred that all columns that form the anti-fogging layer 14 which has a columnar structure be inclined at the angles α within the above-defined range, that is, within the range of 10 to 70 degrees with respect to the line H normal to the substrate 12.

However, the present invention is by no means limited to this particular case and it may include columns that do not satisfy the above-defined angular requirement but which allow for a certain range of manufacturing errors and the like.

More specifically, the columns that account for at least 60% and particularly at least 80% of the surface area of the anti-fogging layer 14 preferably have angles α within the above-defined range.

It is very troublesome to measure the angle α for all the columns of the anti-fogging layer 14. Therefore, the present invention may apply a simplified method in which the cross section of the center of the anti-fogging layer 14 is formed, and when at least 60% of the columns in the central cross section have angles α within the above-defined range, the columns accounting for at least 60% of the surface area of the anti-fogging layer 14 are regarded as having angles α within the above-defined range. It is needless to say that this cross section is one which is parallel to the direction in which the most inclining column is oriented in the anti-fogging layer 14 and is orthogonal to the substrate 12.

In the anti-fogging film (hydrophilic element) 10 of the present invention, the thickness of the anti-fogging layer 14 (not the length of columns but the their height as measured in the direction of the line normal to the substrate 12) is preferably in the range of 100 to 3,000 nm.

By adjusting the thickness of the anti-fogging layer 14 to be at least 100 nm, adequate fog resistance can be obtained consistently; by adjusting the thickness of the anti-fogging layer 14 to be no greater than 3,000 nm, an anti-fogging film that can advantageously prevent the occurrence of haze can be produced consistently.

For various reasons such as the ability to realize the above-described effects in a more advantageous way, the thickness of the anti-fogging layer 14 is more preferably in the range of from 150 to 1,000 nm.

In the present invention, the diameter of the columns is also not limited in any particular way.

As already mentioned by referring to FIG. 3, the inorganic oxide layer of a columnar structure comprising inclined columns is such that independent columns first grew and they then gradually integrated into a single thicker column. The degree of this integration varies with the orientation in the plane of the substrate and the number of columns that integrate in the direction that is parallel to the substrate's plane and in which the columns are inclined (the direction of their inclination), namely, in the direction of the arrow “a” in FIG. 1 (i.e., the direction in which the substrate is inclined in the production process to be described hereinafter) is not as great as the number of columns that integrate in a direction that is parallel to the substrate's plane and which crosses the direction of inclination of the columns at right angles (in a direction perpendicular to the paper on which FIG. 1 is drawn).

In short, the columns that form the columnar structure of the anti-fogging layer 14 assume such an oval shape on its surface that their diameter decreases in the direction of their inclination but increases in a direction that crosses this direction of inclination at right angles.

According to the study by the present inventors, the diameter of the columns as measured on the surface of the anti-fogging layer 14 (which is away from the substrate 12) is 50-10,000 nm along the major axis and 2-300 nm along the minor axis.

If the diameter of the columns that form the anti-fogging layer 14 is adjusted to lie within the stated ranges, one can obtain preferred results in such aspects as fog resistance, stability of fog resistance over time, and the strength of the anti-fogging layer 14.

The gap between columns that form the anti-fogging layer 14 is also not limited in any particular way but it is preferably 2-100 nm.

If the gap between columns is adjusted to lie within the stated range, one can obtain preferred results in such aspects as fog resistance, stability of fog resistance over time, and the strength of the anti-fogging layer 14.

As already mentioned, the columns that compose the columnar structure of the anti-fogging layer 14 are made of fine grains. The diameter of such grains is also not limited in any particular way but it is preferably 2-20 nm; their gap is also not limited in any particular way but it is preferably 0.5-7 nm.

If the diameter of grains that form the columns in the anti-fogging layer 14 and their gap are adjusted to lie within the stated ranges, one can obtain preferred results in such aspects as fog resistance, stability of fog resistance over time, and the strength of the anti-fogging layer 14.

As already mentioned above, the anti-fogging layer 14 in the anti-fogging film 10 of the present invention is formed of columns that are inclined to make a columnar structure and which are spaced apart by an advantageous distance, provided that fine columns integrate to become thicker as they grow upward and that they are formed of grains; as a result, the anti-fogging layer 14 has a wide enough surface area and a suitable amount of spaces, thereby featuring superior fog resistance and strength. In short, the anti-fogging layer 14 of the present invention which is composed of an inclined columnar structure can be designed to have an advantageous filling factor (i.e., the proportion of the inorganic oxide with respect to the overall volume of the layer (film) inclusive of voids).

The filling factor of the anti-fogging layer 14 is also not limited in any particular way but according to the study by the present inventors, it is preferably 0.5-0.9, more preferably 0.7-0.9.

If the filling factor of the anti-fogging layer 14 is adjusted to lie within the stated ranges, one can obtain preferred results in such aspects as fog resistance, stability of fog resistance over time, and the strength of the anti-fogging layer 14.

The anti-fogging layer 14 of the above-described anti-fogging film 10 may typically be deposited (formed) by a vapor-phase deposition technique such as vacuum evaporation. In this case, by setting up the substrate at an angle with respect to the posture it takes in the ordinary deposition process, one can advantageously deposit the anti-fogging layer 14 having a columnar structure that is composed of inclined columns as shown in FIG. 1.

FIG. 4 is a schematic diagram showing how the anti-fogging film 10 having the anti-fogging layer 14 with a columnar structure composed of such inclined columns is deposited by vacuum evaporation.

A vacuum deposition apparatus generally indicated by 20 in FIG. 4 is of such a type that it melts and evaporates a film-depositing material by EB heating with an electron gun; it comprises the electron gun 22, a vacuum chamber 24, an evaporation source (crucible) 26, a vacuum pump 28, a substrate holder 30, a gas introducing means 32, and an EB power source 34. The substrate holder 30 has a built-in temperature control means 30a for controlling the temperature of the substrate 12 and it is connected to an associated drive power source 36.

The illustrated vacuum deposition apparatus 20 basically performs vacuum evaporation by ordinary EB heating, except that the substrate 12 is set up at an inclined posture for film deposition by vacuum evaporation.

More specifically, a film-depositing material M is placed at a specified position in the evaporation source 26 and the substrate 12 is installed in a specified position on the inclined substrate holder 30; thereafter, the vacuum chamber 24 is closed and a vacuum is drawn from its interior by means of the vacuum pump 28. Note here that the film-depositing material may be chosen as appropriate for the anti-fogging layer 14 to be deposited, provided that it may be the same as the material used in ordinary vacuum evaporation (for example, if silicon dioxide is to be deposited, the film-depositing material is SiO₂).

At the point in time when the pressure in the vacuum chamber 24 has reached a specified level, oxygen gas or an inert gas may optionally be introduced by the gas introducing means 32 to adjust the degree of vacuum; then the EB power source 34 is turned on to drive the electron gun 22 (the illustrated electron gun is capable of deflection through 180 degrees but this is not the sole case of the present invention), whereupon an electron beam (EB) is allowed to be incident on the film-depositing material which is heated to melt and its vapor is deposited on the substrate 12. In this process, the power source 36 may optionally be turned on to actuate the temperature control means 30a so that it controls the temperature of the substrate 12.

Note also that the vacuum evaporation as applied to form the anti-fogging film (hydrophilic element) 10 of the present invention is by no means limited to the case where it is performed by EB heating but that any other known heating method may be employed, as exemplified by resistive or inductive heating.

In the production process (film deposition method) under consideration, the substrate 12 is set up inclined, as mentioned above, to form the anti-fogging layer (hydrophilic layer) 14 on the surface of the substrate 12.

In the general practice of vacuum evaporation, the line normal to the substrate 12 (or its surface) and the direction in which the vapor is incident on the substrate 12 (the direction of incidence of the vapor stream) are in alignment with each other during vapor deposition; on the other hand, in the film deposition method according to the present invention, vapor deposition is performed with the line normal to the substrate 12 forming an angle with the direction in which the vapor is incident.

This enables the formation of the anti-fogging film 14 having a columnar structure composed of columns that are inclined in alignment with the direction in which the vapor is incident on the inclined substrate 12.

Except for this inclination of the substrate 12, the formation of the anti-fogging layer (hydrophilic layer) 14 by vacuum evaporation (vapor-phase deposition technique) may be effected in basically the same way as the ordinary vacuum evaporation in consideration of the anti-fogging layer 14 to be formed.

The angle at which the substrate 12 is inclined may be set as appropriate for the desired angle of inclination of columns.

According to the study by the present inventors, if the angle the direction of incidence of the vapor of the film-depositing material (grains of the film-depositing material) on the substrate 12 forms with the normal line to the substrate 12, say, the angle β formed between the line S connecting the center of the evaporation source 26 (the center of the exhaust opening for the vapor of the film-depositing material) to the center of the substrate 12 and the line Hc normal to the center of the substrate 12 is in the range of 20 to 85 degrees, the anti-fogging layer 14 having a columnar structure composed of columns that are inclined such that the already-defined angle α is in the range of 10 to 70 degrees can be fabricated consistently Note here that if the substrate 12 or the evaporation source 26 has such a shape that it is not easy to determine their centers, one may assume an inscribed circle of the substrate 12 or the evaporation source 26 (or the exhaust opening for the vapor of the film-depositing material) and then substitute the center of that circle for the center of the substrate 12 or the evaporation source 26.

The angle β is preferably adjusted to lie within the range of 55 to 75 degrees and by so doing, the anti-fogging layer 14 of a columnar structure comprising columns that are inclined in such a way that the angle α is within an advantageous range of 25 to 45 degrees can be formed consistently.

In the production process described above, the distance between the evaporation source 26 and the substrate 12 (for example, the length of the line S connecting the center of that evaporation source to the center of the substrate) is not limited in any particular way.

If this distance is unduly short, various disadvantages might occur, as exemplified by a variation in the inclination of the columns that are formed on the substrate 12 (i.e., the angle they form with the line normal to the substrate), variations in the quality of the film such as its composition, grains and filling factor, and damage that may be sustained by the substrate 12 due, for example, to the heat generated from the evaporation source 26. On the other hand, if the distance is unduly great, various disadvantages might also occur, as exemplified by variations in the quality of the film such as its composition, grains and filling factor, lowered utilization of constituent materials, as well as lowered productivity and increased cost on account of the need to employ huge and superfluous equipment.

Considering all these factors, the distance between the evaporation source 26 and the substrate 12 is preferably adjusted to lie between 100 and 2,000 nm, more preferably between 300 and 1,000 nm.

If the distance between the evaporation source 26 and the substrate 12 is adjusted to lie within those ranges, the anti-fogging layer 14 comprising columns that are inclined at appropriately uniform angles and which are sufficiently uniform in film quality that less damage will be caused to the substrate 12 (the substrate and the object to be processed) can be formed consistently.

The film-deposition pressure also is not limited in any particular way and it may be set as appropriate for such factors as the anti-fogging layer 14 to be deposited.

The film-deposition pressure affects the filling factor of the anti-fogging layer 14 and the higher this pressure is (the lower the degree of vacuum), the lower the filling factor. The film-deposition pressure also affects the angle of inclination of the columns that compose the anti-fogging layer 14.

According to the study by the present inventors, if the film-deposition pressure is adjusted to lie within the range from 5×10⁻⁴ to 5×10 Pa, one can more consistently form the anti-fogging layer 14 that has a columnar structure composed of columns inclined at angles of 10 to 70 degrees and which has a filling factor of 0.5 to 0.9.

The gas to control the film-deposition pressure may be selected from among various species including nitrogen, helium, neon, argon, krypton, xenon, etc.

As already mentioned, the composition of the anti-fogging layer 14 that is made of an inorganic oxide and which is part of the anti-fogging film 10 of the present invention is preferably close to the theoretical ratio. Accordingly, one may form the anti-fogging layer 14 with oxygen gas being introduced at a film-deposition pressure within the range of from 5×10⁻⁴ to 5×10 Pa.

The vacuum deposition apparatus 20 shown in FIG. 4 is of such a design that the substrate holder 30 has the temperature control means 30a as a built-in device that controls the temperature of the substrate 12 (or the film being deposited).

It is preferred that when forming the anti-fogging layer 14, a suitable method such as one using the temperature control means 30a be optionally employed to control the temperature of the substrate 12 in the process of film deposition, For example, in the case of forming a silicon dioxide film as the anti-fogging layer 14, it is preferably formed with the temperature of the substrate 12 being held not more than 600° C. since the glass transition temperature is about 600 to 800° C. If the substrate 12 is a polymeric film, the anti-fogging layer 14 is preferably formed with the temperature of the substrate 12 being held not more than 80° C. in order to prevent the substrate 12 from deteriorating.

It should also be mentioned that the evaporation rate (deposition rate) to be employed to form the anti-fogging layer 14 is not limited in any particular way. According to the study by the present inventors, the evaporation rate is preferably within a range from about 1 nm/min to about 1,000 nm/min in terms of film thickness per unit time.

While the hydrophilic element of the present invention has been described above in detail for an exemplary case where it is used as an anti-fogging film, it should be understood that the present invention is by no means limited to that particular case and various improvements and modifications can of course be made without departing from the spirit and scope of the present invention.

For instance, the hydrophilic element of the present invention is in no way limited to the anti-fogging film and as already mentioned before, it may be envisaged as a variety of members that have received an anti-fogging treatment, including lenses having the anti-fogging layer formed thereon, automotive or architectural glass plates having the anti-fogging layer formed thereon, and mirrors having the anti-fogging layer formed thereon.

In the foregoing embodiment, the anti-fogging layer (hydrophilic layer) is formed by vacuum evaporation but this is not the sole case of the present invention and the anti-fogging layer may be formed by other methods such as sputtering and ion-assisted evaporation (ion plating).

It should also be noted that the hydrophilic element of the present invention is in no way limited to the anti-fogging material and by making use of its good hydrophilicity and water drop absorbing ability, the hydrophilic element of the present invention can be used in various applications such as humidity modifiers, anti-fouling materials, and adsorbents for hydrophilic substances.

### EXAMPLES

The present invention is described below in greater detail with reference to specific examples.

### Example 1

A 0.7-mm thick synthetic glass plate (Product No. 1737 of Corning Incorporated) as substrate 12 was set up in the vacuum deposition apparatus 20 shown in FIG. 4 and a silicon dioxide film was deposited as an anti-fogging layer on that substrate 12.

Granules (1-3 mm) of silicon dioxide (SiO₂) were used as a film-depositing material.

The substrate 12 was installed on the substrate holder 30 and the film-depositing material was placed in the evaporation source 26; thereafter, the vacuum chamber 24 was closed and the vacuum pump 28 was operated to evacuate the interior of the vacuum chamber 24.

At the point in time when the pressure in the vacuum chamber 24 had reached 8.0×10⁻⁴ Pa, the electron gun 22 was driven so that the silicon dioxide was heated to about 2,000° C. by an electron beam (EB) until it began to melt; at the point in time when the pressure in the vacuum chamber 24 stabilized at 1.5×10⁻³ Pa, a shutter (not shown) was opened, whereupon a silicon dioxide film, namely, the anti-fogging layer 14 started to form on the substrate 12 (in other words, the film-deposition pressure was 1.5×10⁻³ Pa).

At the point in time when the thickness of the anti-fogging layer 14 reached 500 nm, the electron gun 22 was switched off to end the formation of the anti-fogging layer 14.

The deposition rate was set at 300 nm/min as the result of control based on a preliminary experiment. In the process of formation of the anti-fogging layer 14, the temperature of the substrate 12 was set at 50° C. by the temperature control means 30a.

The anti-fogging film 10 thusly having the anti-fogging layer (silicon dioxide film) 14 formed on top of the substrate 12 was produced in such a way that the angle β the line Hc normal to the center of the substrate 12 formed with the line S connecting the center of the evaporation source 26 to the center of the substrate 12 was adjusted to 0, 20, 40, 45, 50, 55, 60, 65, 70, 75, or 60 degrees.

Each of the anti-fogging layers 14 thus formed had a columnar structure composed of a large number of independent columns.

The thus fabricated eleven samples of anti-fogging film respectively had their cross sections observed by SEM to determine the angle α (inclination angle in degrees) the line H normal to the substrate 12 formed with the columns that composed the columnar structure of the anti-fogging layer.

The respective samples of the anti-fogging film 10 were also evaluated for fog resistance, keeping quality of fog resistance, and the adhesion of the anti-fogging layer to the substrate.

### [Fog Resistance]

Each sample of the anti-fogging film 10 (anti-fogging layer 14) was sprayed on the surface with a water vapor and air mixture (40° C.×90% RH) from a distance of 1 cm and the time it took for the sample to fog was measured to check for its fog resistance.

The anti-fogging film that did not fog at all after spraying the water vapor and air mixture for one minute or longer was rated A;

The anti-fogging film that began to fog after spraying the water vapor and air mixture for ten seconds was rated B;

The anti-fogging film that began to fog after spraying the water vapor and air mixture for five seconds was rated C;

The anti-fogging film that began to fog after spraying the water vapor and air mixture for three seconds was rated D;

The anti-fogging film that began to fog after spraying the water vapor and air mixture for one second was rated E.

### [Keeping Quality of Fog Resistance]

The point in time when the time to fog decreased by half in the above-described test for fog resistance (for example, the point in time when the sample that had began to fog in ten seconds in the test for fog resistance deteriorated to such an extent that it began to fog in five seconds) was taken as the time the anti-fogging effect decreased to 50% or less and the lapse of time until the anti-fogging effect decreased to 50% or less was used as a criterion for rating the keeping quality of fog resistance.

The sample whose anti-fogging effect did not decrease to 50% or less after the lapse of half a year was given the score 5;

The sample whose anti-fogging effect decreased to 50% or less within a month was given the score 4;

The sample whose anti-fogging effect decreased to 50% or less within ten days was given the score 3;

The sample whose anti-fogging effect decreased to 50% or less within three days was given the score 2;

The sample whose anti-fogging effect decreased to 50% or less within a day was given the score 1.

### [Adhesion to the Substrate]

The sample that did not experience any separation of the anti-fogging layer 14 in the test for fog resistance was rated good;

The sample that experienced partial separation of the anti-fogging layer 14 in the test for fog resistance was rated fair;

The sample that had already experienced partial separation of the anti-fogging layer 14 before the test for fog resistance was rated poor.

The results are shown in the following Table 1.

TABLE 1

| | | | Keeping | |
|---|---|---|---|---|
| | | | quality of | |
| | | Fog | fog | Adhesion to |
| β [°] | α [°] | resistance | resistance | substrate |
| 0 | 0 | D | 1 | Poor |
| 20 | 10-14 | D | 2 | Good |
| 40 | 17-21 | D | 2 | Good |
| 45 | 20-24 | D | 2 | Good |
| 50 | 22-26 | C | 3 | Good |
| 55 | 24-28 | A | 5 | Good |
| 60 | 27-31 | A | 5 | Good |
| 65 | 29-33 | A | 5 | Good |
| 70 | 34-39 | A | 5 | Good |
| 75 | 40-45 | B | 5 | Good |
| 80 | 47-53 | D | 1 | Fair |

As is clear from Table 1, all samples of anti-fogging film 10 according to the present invention in which the columns in the anti-fogging layer 14 were inclined at angles in the range of 10 to 70 degrees had superior characteristics over the conventional anti-fogging film in which the columns in the anti-fogging layer 14 stood erect on the substrate's surface; in particular, the samples in which the inclination angle of columns (angle α) was between 25 and 45 degrees had very high quality in terms of fog resistance, keeping quality of fog resistance, and adhesion to the substrate.

### Example 2

Seven samples of anti-fogging film 10 were produced as in Example 1, except that the angle β the line Hc normal to the center of the substrate 12 formed with the line S connecting the center of the evaporation source 26 to the center of the substrate 12 was fixed at 60 degrees whereas the thickness of the anti-fogging layer 14 was adjusted to 50 nm, 70 nm, 110 nm, 170 nm, 300 nm, 430 nm, or 1,100 nm.

For the seven samples of anti-fogging film 10 thus fabricated, the angle α (inclination angle) the line H normal to the substrate 12 formed with the columns that composed the columnar structure of the anti-fogging layer 14 was determined by entirely the same method as in Example 1 and the results were within the range of 27 to 31 degrees.

In addition, the seven samples of anti-fogging film 10 were evaluated for their fog resistance by entirely the same method as in Example 1. The results are shown in Table 2 below.

TABLE 2

| Thickness of | |
|---|---|
| anti-fogging | Fog |
| layer [nm] | resistance |
| 50 | D |
| 70 | D |
| 110 | C |
| 170 | B |
| 300 | A |
| 430 | A |
| 1100 | A |

As is clear from Table 2, all samples of anti-fogging film 10 according to the present invention in which the columns in the anti-fogging layer 14 were inclined had superior characteristics over the conventional anti-fogging film in which the columns in the anti-fogging layer 14 stood erect on the substrate's surface; in particular, the samples in which the anti-fogging layer with a thickness of 100 nm or more had superior fog resistance, and those with film thicknesses of 300 nm or more showed markedly outstanding fog resistance.

### Example 3

Two samples of anti-fogging film were fabricated by entirely the same method as in Example 1, with the substrate being inclined at an angle of zero degrees or 60 degrees. As in Example 1, the angle α the line H normal to the substrate 12 formed with the columns that composed the columnar structure of the anti-fogging layer (hydrophilic layer) 14 was determined and the results were entirely the same as in Example 1; the angle α was zero degrees in the sample fabricated with the substrate being inclined at zero degrees but it was in the range of 27 to 31 degrees when the substrate was inclined at 60 degrees.

For both samples, the angle of contact with water was measured with PG-X of MATSUBO Corporation to evaluate their hydrophilicity (performance as a hydrophilic element).

As it turned out, the sample with the angle α at zero degrees had a contact angle of 20 degrees immediately after its fabrication, which increased to 52 degrees after the lapse of a week; on the other hand, the sample with the angle α at 27-31 degrees had a contact angle of 5 degrees or less (5 degrees was the limit of measurement) immediately after its fabrication and even after the lapse of a week, the contact angle still remained at 5 degrees or less.

From these results, the advantageous effects of the present invention are obvious.

What is claimed is:

1. A hydrophilic element comprising:
a base; and
a hydrophilic layer formed of an inorganic oxide on a surface of said base, said hydrophilic layer having a columnar structure composed of columns that form angles of 10 to 70 degrees with respect to a line normal to said base.

2. The hydrophilic element according to claim 1, wherein the hydrophilic layer has a thickness of from 100 to 3,000 nm.

3. The hydrophilic element according to claim 1, which is an anti-fogging film having said base in film form.
